(19) United States
(12) Patent Application Publication
(10) Pub. No.: US 2025/0336178 A1
(43) Pub. Date: Oct. 30, 2025

(54) METHOD, APPARATUS, DEVICE, AND STORAGE MEDIUM FOR OBJECT RECOGNITION

(71) Applicant: Beijing Youzhuju Network Technology Co., Ltd., Beijing (CN)

(72) Inventor: Yicheng Wang, Beijing (CN)

(21) Appl. No.: 19/071,052

(22) Filed: Mar. 5, 2025

(30) Foreign Application Priority Data
Apr. 24, 2024 (CN) 202410502372.8

(51) Int. Cl. G06V 10/74; G06V 10/764; G06V 30/19

(52) U.S. Cl. CPC G06V 10/761; G06V 10/764; G06V 30/19093; G06V 2201/07

(57) ABSTRACT

According to embodiments of the disclosure, a method, an apparatus, a device, and a storage medium for object recognition are provided. The method includes: obtaining an aggregation result of a plurality of objects, the aggregation result including at least one group of objects aggregated based on a similarity; determining a target entity that matches the at least one group of objects for performing object recognition; and providing the at least one group of objects to the target entity. In this way, similar objects can be provided to a matched entity for recognition, thereby improving recognition efficiency and improving accuracy and consistency of recognition results.

### CROSS-REFERENCE

The present application claims priority to Chinese Patent Application No. 202410502372.8, filed on Apr. 24, 2024, and entitled “METHOD, APPARATUS, DEVICE, AND STORAGE MEDIUM FOR OBJECT RECOGNITION”, the entirety of which is incorporated herein by reference.

### FIELD

Example embodiments of the present disclosure generally relate to the field of computer technology, and in particular, to a method, apparatus, a device, and a computer-readable storage medium for object recognition.

### BACKGROUND

In an object recognition scenario, there may be a plurality of similar objects. If the plurality of similar objects are recognized by different entities, the different entities may have different recognition results for different objects, resulting in inconsistent recognition results of similar objects in the object recognition process. In addition, in this case, the recognition efficiency is usually low, which is not desired.

### SUMMARY

In a first aspect of the present disclosure, a method of object recognition is provided. The method includes: obtaining an aggregation result of a plurality of objects, the aggregation result including at least one group of objects aggregated based on a similarity; determining a target entity that matches the at least one group of objects for performing object recognition; and providing the at least one group of objects to the target entity.

In a second aspect of the present disclosure, an apparatus for object recognition is provided. The apparatus includes: an obtaining module configured to obtain an aggregation result of a plurality of objects, the aggregation result including at least one group of objects aggregated based on a similarity; a determining module configured to determine a target entity that matches the at least one group of objects for performing object recognition; and a providing module configured to provide the at least one group of objects to the target entity.

In a third aspect of the present disclosure, an electronic device is provided. The device includes at least one processing unit and at least one memory. The at least one memory is coupled to the at least one processing unit and stores instructions executable by the at least one processing unit. The instructions, when executed by the at least one processing unit, cause the device to perform the method according to the first aspect.

In a fourth aspect of the present disclosure, a computer-readable storage medium is provided. The medium stores a computer program that, when executed by a processor, implements the method according to the first aspect.

It should be understood that the content described in this section is not intended to limit the key features or important features of the embodiments of the present disclosure, nor is it used to limit the scope of the present disclosure. Other features of the present disclosure will become readily understood through the following description.

### BRIEF DESCRIPTION OF THE DRAWINGS

The foregoing and other features, advantages, and aspects of embodiments of the present disclosure become more apparent with reference to the following detailed description and in conjunction with the drawings. Throughout the drawings, the same or similar reference numerals denote the same or similar elements, where:

FIG. 1 is a schematic diagram of an example system in which embodiments of the present disclosure can be implemented;

FIG. 2 is a flowchart of a process for object recognition according to some embodiments of the present disclosure;

FIG. 3 is a flowchart of a process for object recognition according to other embodiments of the present disclosure;

FIG. 4A is a schematic diagram of a process for object aggregation in an incremental scenario according to some embodiments of the present disclosure;

FIG. 4B is a schematic diagram of a process for object aggregation in a stock scenario according to some embodiments of the present disclosure;

FIG. 4C is a schematic diagram of a process for object allocation according to some embodiments of the present disclosure;

FIG. 5 is a schematic diagram of a process for determining a target entity according to some embodiments of the present disclosure;

FIG. 6 is a flowchart of a process for object recognition according to other embodiments of the present disclosure;

FIG. 7 is a block diagram of an apparatus for object recognition according to some embodiments of the present disclosure; and

FIG. 8 shows an electronic device in which one or more embodiments of the present disclosure can be implemented.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a thorough and complete understanding of the present disclosure. It should be understood that the drawings and embodiments of the present disclosure are only for example purposes, and are not intended to limit the protection scope of the present disclosure.

In the description of the embodiments of the present disclosure, the term “include/include” and similar terms should be understood as open inclusion, that is, “include/include but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may be included below.

In this specification, unless explicitly stated, performing a step “in response to A” does not mean that the step is performed immediately after “A”, but may include one or more intermediate steps.

It should be understood that data involved in the technical solutions of the present disclosure (including but not limited to the data itself, the acquisition or use of the data) should comply with the requirements of corresponding laws, regulations, and related provisions.

It should be understood that before using the technical solutions disclosed in the embodiments of the present disclosure, the user should be informed of the type of personal information involved in the present disclosure, the scope of use, the use scenario, and the like in an appropriate manner in accordance with the relevant laws and regulations, and the user's authorization should be obtained.

For example, in response to receiving an active request from a user, prompt information is sent to the user to explicitly prompt the user that the operation requested to be performed will require the acquisition and use of the user's personal information, so that the user can independently choose whether to provide the personal information to software or hardware such as an electronic device, an application, a server, or a storage medium that performs the operations of the technical solutions of the present disclosure, according to the prompt information.

As an optional but non-limiting implementation, in response to receiving an active request from the user, the prompt information may be sent to the user in the form of a pop-up window, for example, and the prompt information may be presented in text in the pop-up window. In addition, the pop-up window may also include a selection control for the user to choose whether to “agree” or “disagree” to provide the personal information to the electronic device.

It should be understood that the above process of notifying and acquiring the user's authorization is only schematic and does not constitute a limitation on the implementations of the present disclosure, and other methods that meet the requirements of relevant laws and regulations may also be applied to the implementations of the present disclosure.

In an object recognition scenario, there may be a plurality of similar objects. A conventional solution for object recognition is to allocate objects to corresponding entities for recognition through random allocation. For example, these objects may first go through a review service to determine whether to recognize them. If it is determined that recognition is to be performed, data related to recognition (such as data for review, data with a high heat label, and so on) of these objects is input to a recognition system. Subsequently, these objects are allocated in a random allocation manner to entities that perform recognition, and each task includes, for example, at least one object. In this way, similar objects are allocated to different target entities. Different target entities may need to understand and/or learn various contents of the similar objects to achieve more accurate object recognition. However, in such an object recognition process, problems such as inconsistent recognition results of similar objects and low recognition efficiency may occur.

In view of this, an embodiment of the present disclosure provides a method of object recognition. According to the method, an aggregation result of a plurality of objects is first obtained, where the aggregation result includes one or more groups of objects aggregated based on a similarity. Then, a target entity that matches the one or more groups of objects for performing object recognition is determined, and at least one group of objects is provided to the target entity for recognition. In this way, similar objects can be provided to the matched entity for recognition, thereby improving recognition efficiency and improving accuracy and consistency of recognition results.

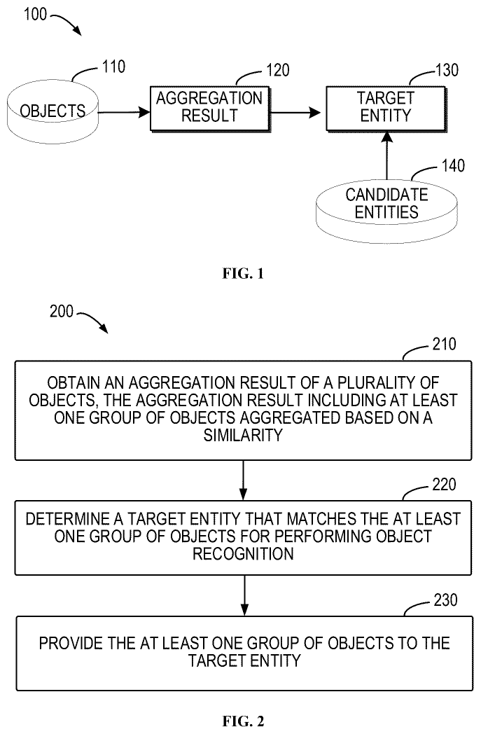

FIG. 1 is a schematic diagram of an example environment 100 in which an embodiment of the present disclosure can be implemented. An object set 110 is shown in the example environment 100, and the object set 110 may include one or more objects. The objects in the object set 110 may be aggregated based on a similarity to obtain an aggregation result 120. The aggregation result 120 may include one or more groups of objects, and each group of objects corresponds to one aggregation result. A target entity 130 may be an entity that is determined from a plurality of candidate entities 140 and matches at least one group of objects in the aggregation result 120. Therefore, at least one group of objects in the aggregation result 120 is provided to the target entity 130, thereby achieving efficient and accurate recognition.

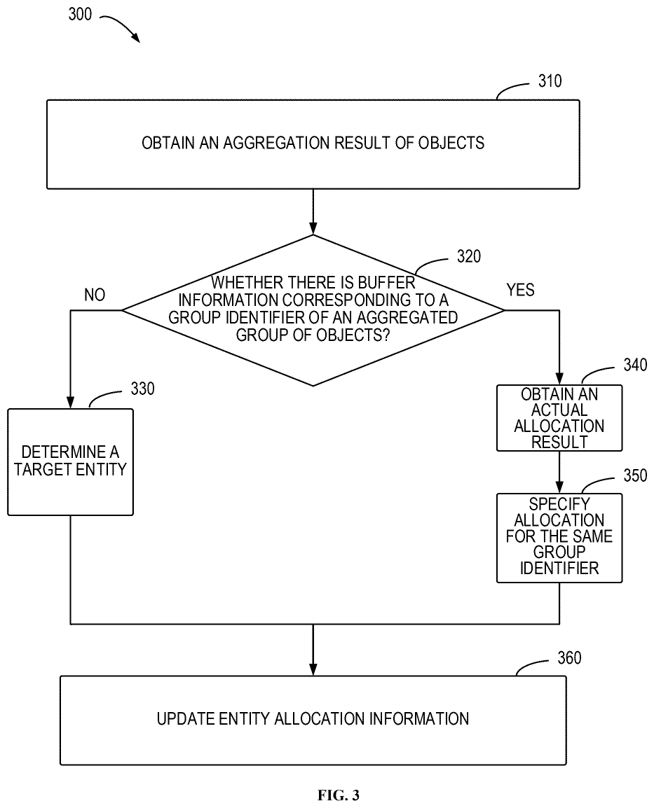

FIG. 2 is a flowchart of a process 200 for object recognition according to some embodiments of the present disclosure. The process 200 is described below with reference to the environment 100 in FIG. 1, and the process 200 may be implemented at an electronic device to which the embodiments of the present disclosure are applicable.

At block 210, the electronic device obtains an aggregation result 120 of a plurality of objects, where the aggregation result includes at least one group of objects aggregated based on a similarity.

In some embodiments, the electronic device may obtain the aggregation result 120 by classifying the plurality of objects 110 based on the similarity. In this way, these objects may be divided into different clusters, that is, a plurality of groups of objects, according to the similarity between the objects.

The similarity may be calculated according to distance metrics such as the Euclidean distance, the Manhattan distance, the Mahalanobis distance, and the cosine angle. It should be understood that the above similarity calculation methods are only examples, without suggesting any limitations, and the similarity calculation method that may be applied in the embodiments of the present disclosure is not limited thereto.

As an alternative, the electronic device may determine a similarity between an object to be aggregated and a group of objects in the at least one group of objects included in the aggregation result. If the similarity is greater than a predetermined threshold, the object to be aggregated may be added to the group of objects.

At block 220, the electronic device determines a target entity 130 that matches the at least one group of objects for performing object recognition.

The target entity 130 may be determined in a variety of ways. For example, at least one of text information or image information of the at least one group of objects may be determined, and entity information of a plurality of candidate entities may be obtained. The entity information indicates at least one of a recognition duration or a recognition accuracy of each of the plurality of candidate entities. Then, the target entity 130 may be determined from the plurality of candidate entities 140 based on the entity information and the at least one of the text information or the image information.

In some embodiments, the target entity 130 may also be determined from the plurality of candidate entities 140 in various ways. For example, at least one of a text feature representation and/or an image feature representation of a group of objects may be determined based on the at least one of the text information or the image information, and entity feature representations of the plurality of candidate entities may be determined based on the entity information. The target entity 130 is determined by applying the at least one of the text feature representation or the image feature representation and the entity feature representations to a trained entity selection model.

The entity selection model may be a model pre-trained for performing entity selection. For example, an initial model may be trained by using a reference text feature representation, a reference image feature representation, and a reference entity feature representation as input and using a recognition duration and a recognition accuracy of a reference entity as output. In this way, the above entity selection model may be obtained.

As an alternative, in addition to the above manner of determining the target entity 130, entity allocation information may be further obtained, and the entity allocation information at least indicates a correspondence between a group of objects and an entity that performs object recognition on the group of objects. Based on the entity allocation information, an entity corresponding to a group identifier of the at least one group of objects may be determined as the target entity 130.

In addition, in some embodiments, the relationship between an entity and an object allocated to the entity, for example, the entity allocation information, may be continuously updated. For example, the entity allocation information may be updated based on the target entity and the at least one group of objects. The entity allocation information at least indicates a correspondence between a group of objects and an entity that performs object recognition on the group of objects.

At block 230, the electronic device provides the at least one group of objects to the target entity. In this way, the group of objects received by the target entity may be objects that better match the target entity in terms of recognition, thereby improving efficiency and accuracy for the recognition.

FIG. 3 is a flowchart of a process 300 for object recognition according to some embodiments of the present disclosure. The embodiments shown in FIG. 3 are a specific implementation of the embodiments shown in FIG. 2. It should be understood that the process 300 in FIG. 3 is only for example and not restrictive. Similar to FIG. 2, the process 300 in FIG. 3 is also described with reference to the environment 100 in FIG. 1, and the process 300 may be implemented at an electronic device to which the embodiments of the present disclosure are applicable.

In the process 300, at block 310, the electronic device obtains an aggregation result 120 of objects. The aggregation result 120 may include at least one group of objects aggregated based on a similarity. Each aggregated group of objects may correspond to a group identifier, and the group identifier may include information of a corresponding group of objects, which is used to match a target entity and distinguish the aggregated objects.

At block 320, the electronic device determines whether there is buffer information corresponding to a group identifier of an aggregated group of objects.

In some embodiments, if it is determined that there is no buffer information corresponding to the group identifier of the aggregated group of objects, at least one of text information or image information of the aggregated group of objects is obtained, and entity information of a plurality of candidate entities is obtained. A target entity 130 is determined from the plurality of candidate entities 140 based on the at least one of the text information or the image information and the entity information, that is, the process 300 proceeds to block 330.

At block 330, the electronic device determines the target entity 130. In some embodiments, a target entity 130 that matches the at least one group of objects for performing object recognition is determined. The determined target entity 130 may be an entity that has high efficiency and high accuracy in performing a recognition task of the aggregated group of objects among the plurality of candidate entities. After the target entity is determined, the at least one group of objects is provided to the target entity 130, and entity allocation information is updated based on a mapping relationship between the target entity and the aggregated group of objects. The entity information may indicate a recognition duration of each of the plurality of candidate entities 140, and the entity information may further indicate a recognition accuracy of each of the plurality of candidate entities 140.

On the other hand, in some embodiments, if it is determined that there is buffer information corresponding to the group identifier of the aggregated group of objects, an actual allocation result may be obtained based on the buffer information corresponding to the group identifier. That is, the process 300 proceeds to block 340.

At block 340, the electronic device obtains an actual allocation result. In some embodiments, the actual allocation result may be an entity corresponding to an aggregated group of objects in a historical allocation process.

At block 350, the electronic device specifies allocation for the same group identifier. In some embodiments, the electronic device may determine, based on the actual allocation result, to allocate the aggregated group of objects to the entity, and allocate a group of objects with the same group identifier as the aggregated group of objects to the entity as well.

At block 360, the electronic device updates the entity allocation information. As mentioned above, the entity allocation information may indicate a correspondence between a group of objects and an entity that performs object recognition on the group of objects. The entity allocation information may be updated based on a mapping relationship between the target entity and the aggregated group of objects and a mapping relationship between the target entity and a group of objects with the same group identifier as the aggregated group of objects.

In some embodiments, the entity allocation information may be updated based on the aggregation result of the objects, which may improve the accuracy of matching between the objects and the target entity, and improve the efficiency of object recognition.

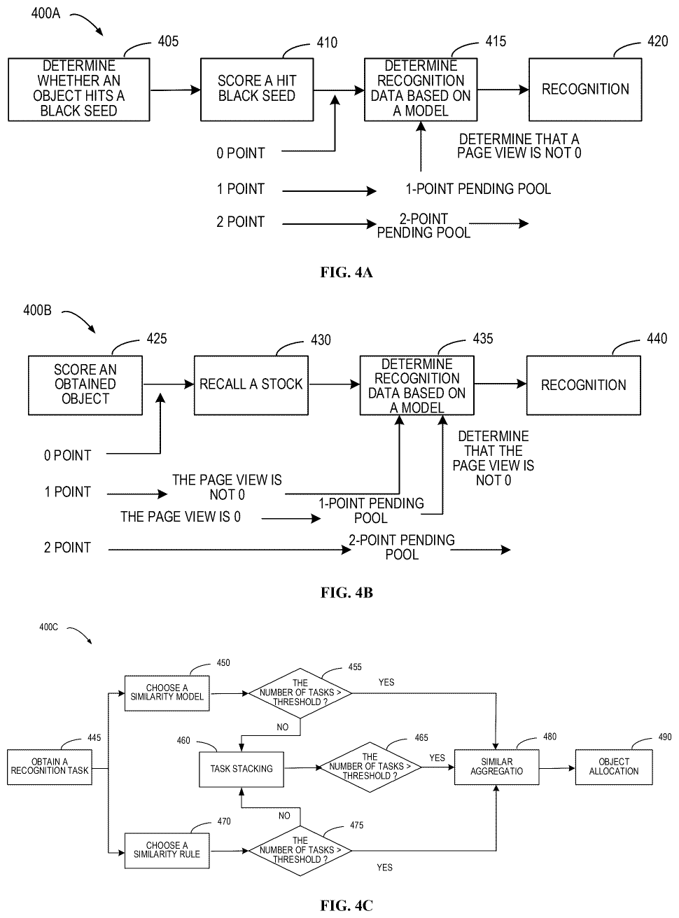

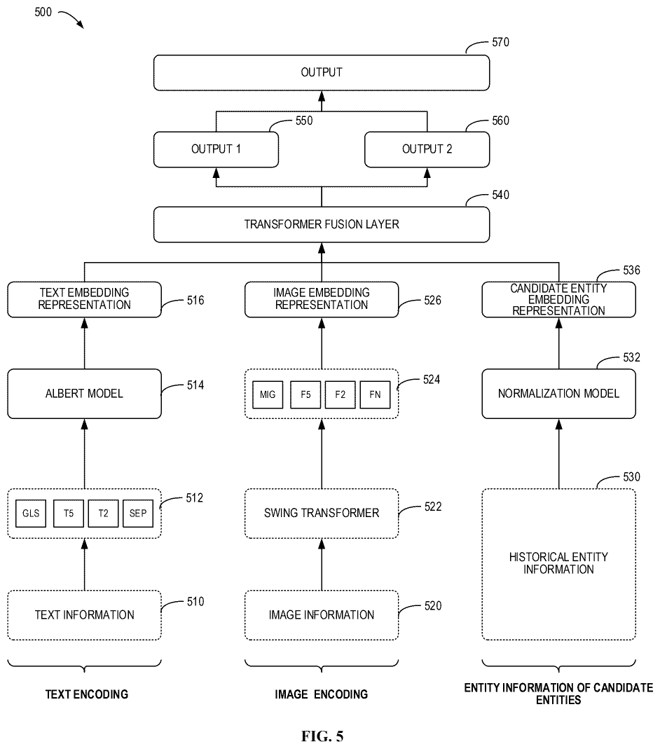

Object aggregation may be implemented in various scenarios, such as an incremental scenario and a stock scenario. The aggregation of similar objects in an incremental scenario and the aggregation of similar objects in a stock scenario are described below with FIG. 4A and FIG. 4 as examples, respectively.

FIG. 4A is a schematic diagram of a process 400A for object aggregation in an incremental scenario according to some embodiments of the present disclosure.

The incremental scenario of object aggregation means that there already exists one aggregated group of objects or a plurality of aggregated groups of objects, and there is one or more newly added objects that need to be aggregated. The one or more newly added objects may be aggregated with the existing one aggregated group of objects or the plurality of aggregated groups of objects based on the similarity. Alternatively, the one or more newly added objects may be aggregated into one newly added aggregated group of objects or a plurality of aggregated groups of objects based on the similarity.

At block 405, it is determined whether an object hits a black seed. In some embodiments, the object may include a plurality of similar objects, may include a plurality of dissimilar objects, or may include both a plurality of similar objects and a plurality of dissimilar objects.

At block 410, a hit black seed is scored. In some embodiments, the hit black seed may be determined and scored, and then whether to enter a model or a pending pool may be determined based on the score of the hit black seed. Assuming that a score of a hit black seed may be 0 point, 1 point, and 2 points, if the score of the hit black seed is 0 point, it is determined that the hit black seed enters the model. If the score of the hit black seed is 1 point or 2 points, it is determined that the hit black seed may enter a corresponding pending pool. The black seed with a score of 1 point corresponds to a 1-point pending pool, and the black seed with a score of 2 points corresponds to a 2-point pending pool. For the black seed that enters the 1-point pending pool, whether a page view is 0 is determined again, and if it is determined that the page view is not 0, the black seed enters the model.

In some examples, for the black seed with a score of 1 point, its page view (Page View, PV) needs to be determined. If the page view is not 0, the black seed enters a review queue. For the black seed with a score of 2 points, a filtering processing needs to be performed.

At block 415, recognition data is determined based on the model, and a recognition result is obtained at block 420.

In some embodiments, the hit black seed is input into the model, and recognition data for a recognition process, such as data for review, a high heat label, and so on, may be determined.

FIG. 4B is a schematic diagram of a process 400B for object aggregation in a stock scenario according to some embodiments of the present disclosure. The stock scenario of object aggregation refers to a case where a plurality of objects are directly aggregated.

At block 425, an obtained object is scored. In some embodiments, it is assumed that the score of the object may be 0 point, 1 point, and 2 points. If the score of the object is 0 point, a stock is recalled, that is, block 430 is performed. If the score of the object is 1 point, a page view of the object is further determined. If the score of the object is 1 point and the page view of the object is not 0, a model is entered, and a same task group identifier is assigned to a group of objects. If the score of the object is 1 point and the page view of the object is 0, a 1-point pending pool is entered, and whether the page view of the object is 0 is determined again. If it is determined that the page view of the object is not 0, the model is entered.

In some examples, when an object recognition task is created, a corresponding task identifier may be added to a task with an association relationship, such as an sGroupTask field. The addition of the corresponding task identifier may be performed by invoking a CreateTask interface. A created batch of task identifiers are passed in as parameters, and a task group is generated.

At block 430, a stock is recalled. In some embodiments, if the score of the object is 0 point, the stock is recalled, and then recognition data is determined based on the model at block 435 and a recognition result is obtained at block 440. In some embodiments, in the process of determining the recognition data based on the model, the input may be an object for which the stock recall is completed, an object with a score of 1 point and a page view not equal to 0, or an object that enters the 1-point pending pool and is determined to have a page view not equal to 0.

FIG. 4C is a schematic diagram of a process 400C for object allocation according to some embodiments of the present disclosure.

First, at block 445, a recognition task is obtained. In some embodiments, each recognition task corresponds to a plurality of similar objects. After the recognition task is obtained, whether the obtained recognition task is recognized based on a similarity model or a similarity rule is determined. If the recognition task may be recognized based on the similarity model, the obtained recognition task is recognized based on the similarity model, and block 450 is performed. If the recognition task cannot be recognized based on the similarity model, it is determined that the obtained recognition task is recognized based on the similarity rule, and block 470 is performed.

At block 450, a similarity model is selected. In some embodiments, the similarity model is obtained based on pre-training. The similarity model is configured to recognize similar objects. After determining that recognition is performed based on the similarity model, whether the number of tasks is greater than a threshold is determined, that is, block 455 is performed.

At block 455, whether the number of tasks is greater than the threshold. In some embodiments, the threshold may be obtained based on presetting. If the number of tasks is greater than the threshold, similar aggregation is performed, that is, block 480 is performed. If the number of tasks is less than or equal to the threshold, task stacking is performed, that is, block 460 is performed.

At block 460, the tasks are stacked. In some embodiments, the received tasks are stacked, and at block 465, whether the number of stacked tasks is greater than the threshold is re-determined based on a preset duration. In some embodiments, if the number of tasks is greater than the threshold, the similar aggregation is performed at block 480.

At block 470, a similarity rule is selected. In some embodiments, the similarity rule is obtained based on presetting, and the similarity rule is configured to recognize similar objects. The objects aggregated based on the similarity rule are objects that cannot be aggregated based on the similarity model.

After determining that recognition is performed based on the similarity rule, whether the number of tasks is greater than the threshold is determined at block 475. In some embodiments, if the number of tasks is less than or equal to the threshold, task stacking is performed, that is, the process 400C returns to block 460. If the number of tasks is greater than the threshold, the similar aggregation is performed at block 480. In some embodiments, aggregation may be performed on objects that are determined to have a certain similarity, so as to obtain one aggregated group of objects.

For the one aggregated group of objects or the plurality of aggregated groups of objects, an object allocation operation may be performed, for example, an object is allocated to a corresponding entity.

Object allocation may be performed at block 490. For example, the one aggregated group of objects or the plurality of aggregated groups of objects may be matched with a plurality of entities in the candidate entities, and then a corresponding target entity may be determined.

FIG. 5 is a schematic diagram of a process 500 for determining a target entity according to some embodiments of the present disclosure. The process 500 is described below with reference to FIG. 1.

Before object allocation is performed, content features of an object need to be extracted, where the content features of the object include text information and image information. The content features may be extracted, for example, by FashionBERT. In addition, image embedding representation information may be extracted, which may be performed, for example, by using ResNet. The text features of the object are extracted by using a pre-trained model (such as ALBERT) to extract text. The learning objectives of the pre-trained model are the task processing duration (AHT) and the sampling inspection accuracy. Pareto optimization is introduced at the loss fusion stage to perform loss fusion, and the model can learn long-tailed information better for the loss of long-tailed data distribution.

In an object allocation scenario, the content features of the object may be extracted by using the pre-trained model, and the pre-trained model may be FashionProduct, to extract the text information of the object, the image information of the object, and the historical entity information of the candidate entities.

After the text information of the object, the image information of the object, and the historical entity information of the candidate entities are extracted, text information 510, image information 520, and historical entity information 530 are input separately.

In some embodiments, an ALBERT model 514 is configured to process an input text feature representation to obtain a text embedding representation. A corresponding text feature representation 512 may be obtained based on the text information 510, and the obtained text feature representation 512 is input into the ALBERT model 514, so that a text embedding representation 516 may be obtained.

In some embodiments, a SWING Transformer 522 is configured to process input image information to obtain a corresponding image feature representation. After the image information 520 is input into the SWING Transformer 522, a corresponding image feature representation 524 may be obtained. An image embedding representation 526 may be obtained based on the image feature representation 524.

The historical entity information 530 indicates at least one of a recognition duration or a recognition accuracy of each of the plurality of candidate entities. A normalization model 532 is input based on the historical entity information 530 to perform normalization processing, so as to obtain a candidate entity embedding representation 536. The normalization model 532 may normalize data by taking a logarithm.

The obtained text embedding representation 516, image embedding representation 526, and candidate entity embedding representation 536 are input into a Transformer fusion layer 540 for processing. The Transformer fusion layer 540 processes the input embedding representations to obtain an output 1 550 and an output 2 560, where the output 1 may be, for example, the recognition duration in the entity information, and the output 2 may be, for example, the recognition accuracy in the entity information.

The entity information determines entity feature representations of the plurality of candidate entities. At least one of the text feature representation or the image feature representation and the entity feature representations are applied to a trained entity selection model to determine the target entity. The entity selection model is trained by using a reference text feature representation, a reference image feature representation, and a reference entity feature representation as input and using a recognition duration and a recognition accuracy of a reference entity as output.

At block 570, an output may be obtained based on the text information and the image information as well as the output 1 550 and the output 2 560, which is, for example, a target entity that matches the text information 510 and/or the image information 520.

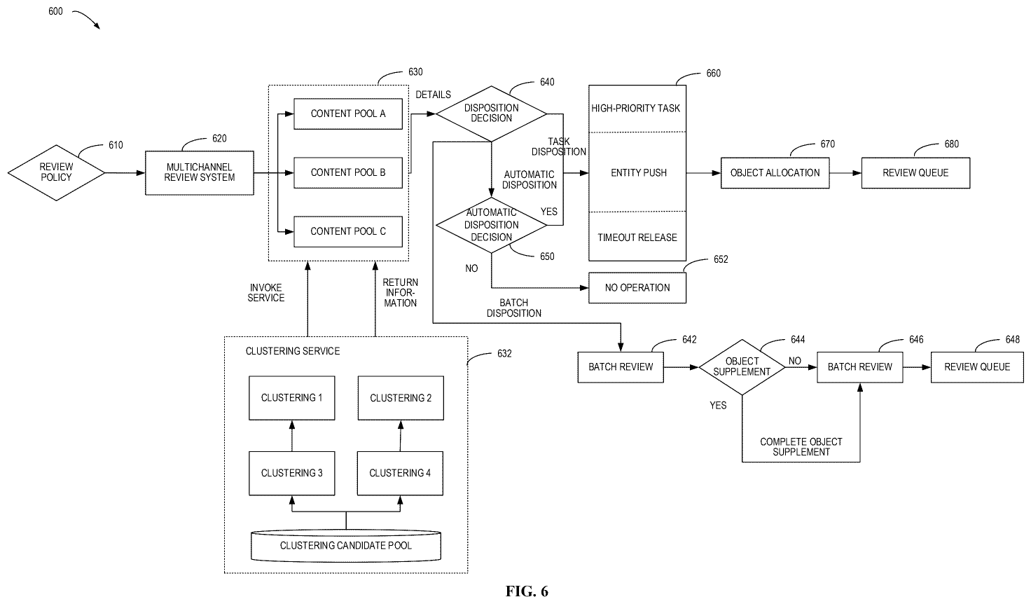

FIG. 6 is a flowchart of a process 600 for object recognition according to some embodiments of the present disclosure. The process 600 is described below with reference to FIG. 1.

Based on a review policy 610, whether object recognition is to be performed is determined. If it is determined that object recognition is to be performed, an object recognition task is generated, and the object recognition task is input into a multichannel review system (Multichannel Moderation System, MCMS) 620 for allocation. The multichannel review system may perform a flexible hierarchical review process architecture based on business-related data, such as risk, value, and the like.

The multichannel review system 620 may allocate an object to a content pool set 630 based on content features. The content pool set 630 may include a content pool A, a content pool B, and a content pool C. It should be understood that the content pool set 630 is only for example, without suggesting any limitations, and the content pool set 630 may include any number of content pools.

In some embodiments, the object recognition task may be accurately understood through the content features in the content pool set 630, a review mode of the object recognition task may be determined based on a risk level, and the task may be ranked based on a task value. A review time and a review mode that match the current object recognition task may also be determined through the content pool set 630. In addition, during the process of waiting for the object recognition task to be reviewed, a preset event may be used for triggering, to change the task review mode, the review sequence, and the review result.

The content pool set 630 may be invoked by a clustering service 632, or may receive return information sent by the clustering service 632. The clustering service 632 may determine a plurality of clusters based on a clustering candidate pool, for example, determining a clustering 1, a clustering 2, a clustering 3, and a clustering 4 from the clustering candidate pool, or any number of clusters may be determined from the clustering candidate pool based on a business requirement.

The one aggregated group of objects or the plurality of aggregated groups of objects obtained by the content pool set 630 may be determined through a disposition decision 640 on whether to perform disposition. If it is determined that disposition is to be performed, a disposition manner is determined based on the disposition decision 640, where the disposition manner includes automatic disposition, task disposition, and batch disposition.

If it is determined at block 640 that the disposition manner is batch disposition, the process 600 proceeds to batch review 642. For the one aggregated group of objects or the plurality of aggregated groups of objects after the batch review 642 is performed, whether object supplement needs to be performed is determined at 644. The object supplement is considered in the incremental scenario of object aggregation. After the object supplement is completed or when it is determined that the object supplement does not need to be performed, the batch review is performed again at block 646. Based on the batch review at block 646, a review queue 648 may be obtained, where the review queue 648 includes a group of objects or a plurality of groups of objects that have been reviewed and aggregated.

If it is determined at block 640 that the disposition manner is automatic disposition, the process 600 proceeds to block 650, that is, determining whether an automatic disposition decision is matched. The automatic disposition decision is configured to cause a certain proportion of one aggregated group of objects or a plurality of aggregated groups of objects that meet the decision to enter a high-priority task, for example, 10% of one aggregated group of objects or a plurality of aggregated groups of objects that meet the decision may be caused to enter the high-priority task. The processing priority of the high-priority task may be the highest priority. If it is determined that the automatic disposition decision is matched, the certain proportion of the one aggregated group of objects or the plurality of aggregated groups of objects that meet the decision are added to the high-priority task. If it is determined that the automatic disposition decision is not matched, no operation is performed on the aggregated objects at block 652, that is, no operation is performed.

If it is determined at block 640 that the disposition manner is task disposition, the process 600 proceeds to block 660. The block 660 includes a high-priority task, entity push, and timeout release. The processing priority of the high-priority task is the highest priority, and the high-priority task is preferentially processed. The entity push may be used for, upon the number of recognition tasks in a review queue of an entity reaching a predetermined threshold, pushing a recognition task that needs to be allocated to an entity whose number of tasks does not reach the predetermined threshold. The timeout release is used for releasing a recognition task if the recognition task is waiting while the number of recognition tasks in review queues of online entities has reached the predetermined threshold, and then the recognition task returns to the review policy 610 for re-review. After the block 660, if there is still a recognition task not allocated, object allocation is performed at block 670 to match a target entity for the recognition task that is not allocated. After the object allocation is completed at block 670, a review queue 680 is obtained, where the review queue 680 includes a group of objects or a plurality of groups of objects that have been reviewed and aggregated.

In this way, object recognition may be performed based on a matched entity of the one aggregated group of objects or a plurality of aggregated groups of objects. Similar objects may be matched to the corresponding target entity. Therefore, the recognition efficiency may be improved, and the accuracy and consistency of recognition results may also be improved.

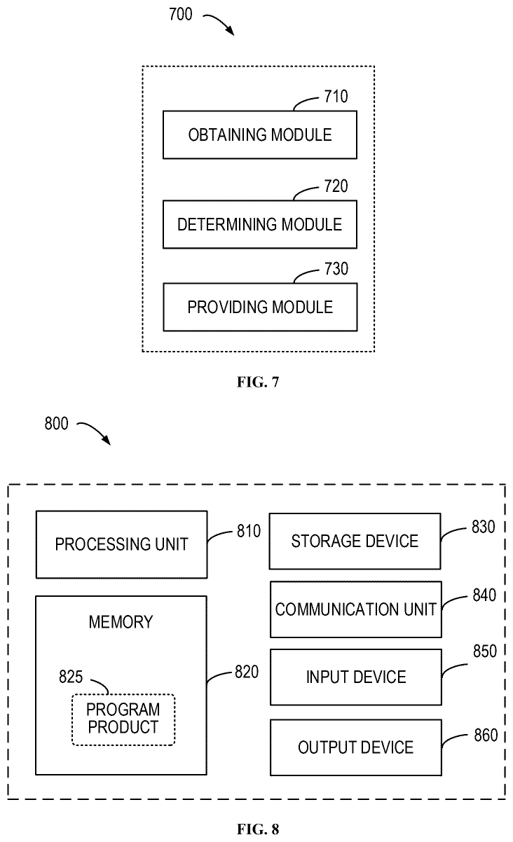

FIG. 7 shows a schematic block diagram of an apparatus 700 for object recognition according to some embodiments of the present disclosure. The apparatus 700 may be implemented as an electronic device or included in an electronic device. Each module/component in the apparatus 700 may be implemented by hardware, software, firmware, or any combination thereof.

As shown in the figure, the apparatus 700 includes an obtaining module 710 configured to obtain an aggregation result of a plurality of objects, where the aggregation result includes at least one group of objects aggregated based on a similarity. The apparatus 700 also includes a determining module 720 configured to determine a target entity that matches the at least one group of objects for performing object recognition. The apparatus 700 also includes a providing module 730 configured to provide the at least one group of objects to the target entity.

In some embodiments, the obtaining module 710 is further configured to obtain the aggregation result by classifying the plurality of objects based on the similarity.

In some embodiments, the obtaining module 710 is further configured to: determine a similarity between an object to be aggregated and a group of objects in the at least one group of objects included in the aggregation result; and in response to determining that the similarity is greater than a predetermined threshold, add the object to be aggregated to the group of objects.

In some embodiments, the determining module 720 is further configured to: determine at least one of text information or image information of the at least one group of objects; obtain entity information of a plurality of candidate entities, the entity information indicating at least one of a recognition duration or a recognition accuracy of each of the plurality. of candidate entities; and determine the target entity from the plurality of candidate entities based on the at least one of the text information or the image information and the entity information.

In some embodiments, the determining module 720 is further configured to: determine at least one of a text feature representation or an image feature representation of the group of objects based on the at least one of the text information or the image information; determine entity feature representations of the plurality of candidate entities based on the entity information; and apply the at least one of the text feature representation or the image feature representation and the entity feature representations to a trained entity selection model to determine the target entity.

In some embodiments, the entity selection model is trained by using a reference text feature representation, a reference image feature representation, and a reference entity feature representation as input and using a recognition duration and a recognition accuracy of a reference entity as output.

In some embodiments, the determining module 720 is further configured to: obtain entity allocation information indicating at least a correspondence between a group of objects and an entity that performs object recognition on the group of objects; and determine, based on the entity allocation information, an entity corresponding to a group identifier of the at least one group of objects as the target entity.

In some embodiments, the apparatus 700 further includes an update module configured to update entity allocation information based on the target entity and the at least one group of objects, the entity allocation information indicating at least a correspondence between a group of objects and an entity that performs object recognition on the group of objects.

FIG. 8 shows a block diagram of an electronic device 800 in which one or more embodiments of the present disclosure may be implemented. It should be understood that the electronic device 800 shown in FIG. 8 is only for example and should not constitute any limitation on the functions and scope of the embodiments described herein. The electronic device 800 shown in FIG. 8 may be used to implement the apparatus 700 in FIG. 7.

As shown in FIG. 8, the electronic device 800 is in the form of a general computing device. The components of the electronic device 800 may include, but are not limited to, one or more processors or processing units 810, a memory 820, a storage device 830, one or more communication units 840, one or more input devices 850, and one or more output devices 880. The processing unit 810 may be a physical or virtual processor and can perform various processes according to programs stored in the memory 820. In a multiprocessor system, multiple processing units execute computer-executable instructions in parallel to improve the parallel processing capability of the electronic device 800.

The electronic device 800 generally includes multiple computer storage media. Such media may be any available media accessible by the electronic device 800, including but not limited to volatile and non-volatile media, and detachable and non-detachable media. The memory 820 may be a volatile memory (such as a register, a cache, a random-access memory (RAM)), a non-volatile memory (such as a read-only memory (ROM), an electrically erasable programmable read-only memory (EEPROM), a flash memory), or a combination thereof. The storage device 830 may be a detachable or non-detachable medium, and may include a machine-readable medium, such as a flash drive, a disk, or any other medium, which may be used to store information and/or data and may be accessed within the electronic device 800.

The electronic device 800 may further include another detachable/non-detachable, volatile/non-volatile storage medium. Although not shown in FIG. 8, a disk drive for reading from or writing to a detachable, non-volatile disk (for example, a “floppy disk”) and an optical disk drive for reading from or writing to a detachable, non-volatile optical disk may be provided. In these cases, each drive may be connected to a bus (not shown) by one or more data medium interfaces. The memory 820 may include a computer program product 825 having one or more program modules configured to perform various methods or actions of various embodiments of the present disclosure.

The communication unit 840 communicates with other electronic devices through a communication medium. In addition, the functions of components of the electronic device 800 may be implemented by a single computing cluster or multiple computing machines that can communicate through communication connections. Therefore, the electronic device 800 may operate in a networked environment using a logical connection with one or more other servers, network personal computers (PCs), or another network node.

The input device 850 may be one or more input devices, such as a mouse, a keyboard, a trackball, or the like. The output device 880 may be one or more output devices, such as a display, a speaker, a printer, or the like. The electronic device 800 may also communicate with one or more external devices (not shown) such as storage devices, display devices, or the like, with one or more devices that allow a user to interact with the electronic device 800, or with any device (for example, a network card, a modem, or the like) that allows the electronic device 800 to communicate with one or more other electronic devices, through the communication unit 840 as required. Such communication may be performed via an input/output (I/O) interface (not shown).

According to an example implementation of the present disclosure, a computer-readable storage medium is provided, on which computer-executable instructions are stored, where the computer-executable instructions are executed by a processor to implement the above-described method. According to an example implementation of the present disclosure, a computer program product is also provided, which is tangibly stored on a non-transitory computer-readable medium and includes computer-executable instructions, and the computer-executable instructions are executed by a processor to implement the above-described method.

Various aspects of the present disclosure are described herein with reference to the flowcharts and/or block diagrams of the method, apparatus, device, and computer program product implemented according to the present disclosure. It should be understood that each block of the flowcharts and/or block diagrams and the combinations of blocks in the flowcharts and/or block diagrams may be implemented by computer-readable program instructions.

These computer-readable program instructions may be provided to the processing unit of a general-purpose computer, a special-purpose computer, or other programmable data processing apparatus, so as to produce a machine, so that these instructions, when executed by the processing unit of the computer or other programmable data processing apparatus, produce a device that implements the functions/actions specified in one or more blocks of the flowcharts and/or block diagrams. These computer-readable program instructions may also be stored in a computer-readable storage medium, and these instructions cause the computer, the programmable data processing apparatus, and/or other devices to work in a specific manner. Therefore, the computer-readable medium storing the instructions includes a product, which includes instructions for implementing various aspects of the functions/actions specified in one or more blocks of the flowcharts and/or block diagrams.

The computer-readable program instructions may be loaded onto a computer, other programmable data processing apparatus, or other device, such that a series of operational steps are performed on the computer, other programmable data processing apparatus, or other device to produce a computer-implemented process, such that the instructions executed on the computer, other programmable data processing apparatus, or other device implement the functions/actions specified in one or more blocks of the flowcharts and/or block diagrams.

The flowcharts and block diagrams in the drawings show the architecture, functionality, and operation of possible implementations of systems, methods, and computer program products according to multiple implementations of the present disclosure. In this regard, each block in the flowcharts or block diagrams may represent a module, a program segment, or a portion of an instruction, and the module, the program segment, or the portion of the instruction includes one or more executable instructions for implementing the specified logical functions. In some alternative implementations, the functions noted in the blocks may also occur out of the order noted in the drawings. For example, two consecutive blocks may, in fact, be performed substantially concurrently, or the blocks may sometimes be performed in the reverse order, depending on the functions involved. It should also be noted that each block of the block diagrams and/or flowcharts and the combination of blocks in the block diagrams and/or flowcharts may be implemented by a dedicated hardware-based system that performs the specified functions or actions, or may be implemented by a combination of dedicated hardware and computer instructions.

Various implementations of the present disclosure have been described above, and the above description is for example, non-exhaustive, and not limited to the disclosed implementations. Many modifications and variations are obvious to ordinary skill in the art without departing from the scope and spirit of the described implementations. The selection of terms used in this specification aims to best explain the principles of the implementations, the practical applications, or the improvements to the technologies in the market, or to enable other ordinary skill in the art to understand the implementations disclosed herein.

1. A method of object recognition, comprising:
obtaining an aggregation result of a plurality of objects, the aggregation result comprising at least one group of objects aggregated based on a similarity;
determining a target entity that matches the at least one group of objects for performing object recognition; and
providing the at least one group of objects to the target entity.

2. The method according to claim 1, wherein obtaining the aggregation result of the plurality of objects comprises:
obtaining the aggregation result by classifying the plurality of objects based on the similarity.

3. The method according to claim 1, wherein obtaining the aggregation result of the plurality of objects comprises:
determining a similarity between an object to be aggregated and a group of objects in the at least one group of objects comprised in the aggregation result; and
in response to determining that the similarity is greater than a predetermined threshold, adding the object to be aggregated to the group of objects.

4. The method according to claim 1, wherein determining the target entity comprises:
determining at least one of text information or image information of the at least one group of objects;
obtaining entity information of a plurality of candidate entities, the entity information indicating at least one of a recognition duration or a recognition accuracy of each of the plurality of candidate entities; and
determining the target entity from the plurality of candidate entities based on the at least one of the text information or the image information and the entity information.

5. The method according to claim 4, wherein determining the target entity from the plurality of candidate entities comprises:
determining at least one of a text feature representation or an image feature representation of the group of objects based on the at least one of the text information or the image information;
determining entity feature representations of the plurality of candidate entities based on the entity information; and
applying the at least one of the text feature representation or the image feature representation and the entity feature representations to a trained entity selection model to determine the target entity.

6. The method according to claim 5, wherein the entity selection model is trained by using a reference text feature representation, a reference image feature representation, and a reference entity feature representation as input and using a recognition duration and a recognition accuracy of a reference entity as output.

7. The method according to claim 1, wherein determining the target entity comprises:
obtaining entity allocation information indicating at least a correspondence between a group of objects and an entity that performs object recognition on the group of objects; and
determining, based on the entity allocation information, an entity corresponding to a group identifier of the at least one group of objects as the target entity.

8. The method according to claim 1, further comprising:
updating entity allocation information based on the target entity and the at least one group of objects, the entity allocation information indicating at least a correspondence between a group of objects and an entity that performs object recognition on the group of objects.

9. An electronic device, comprising:
at least one processing unit; and
at least one memory coupled to the at least one processing unit and storing instructions executable by the at least one processing unit, the instructions, when executed by the at least one processing unit, causing the device to perform acts comprising:
obtaining an aggregation result of a plurality of objects, the aggregation result comprising at least one group of objects aggregated based on a similarity;
determining a target entity that matches the at least one group of objects for performing object recognition; and
providing the at least one group of objects to the target entity.

10. The device according to claim 9, wherein obtaining the aggregation result of the plurality of objects comprises:
obtaining the aggregation result by classifying the plurality of objects based on the similarity.

11. The device according to claim 9, wherein obtaining the aggregation result of the plurality of objects comprises:
determining a similarity between an object to be aggregated and a group of objects in the at least one group of objects comprised in the aggregation result; and
in response to determining that the similarity is greater than a predetermined threshold, adding the object to be aggregated to the group of objects.

12. The device according to claim 9, wherein determining the target entity comprises:
determining at least one of text information or image information of the at least one group of objects;
obtaining entity information of a plurality of candidate entities, the entity information indicating at least one of a recognition duration or a recognition accuracy of each of the plurality of candidate entities; and
determining the target entity from the plurality of candidate entities based on the at least one of the text information or the image information and the entity information.

13. The device according to claim 12, wherein determining the target entity from the plurality of candidate entities comprises:
determining at least one of a text feature representation or an image feature representation of the group of objects based on the at least one of the text information or the image information;
determining entity feature representations of the plurality of candidate entities based on the entity information; and
applying the at least one of the text feature representation or the image feature representation and the entity feature representations to a trained entity selection model to determine the target entity.

14. The device according to claim 13, wherein the entity selection model is trained by using a reference text feature representation, a reference image feature representation, and a reference entity feature representation as input and using a recognition duration and a recognition accuracy of a reference entity as output.

15. The device according to claim 9, wherein determining the target entity comprises:
obtaining entity allocation information indicating at least a correspondence between a group of objects and an entity that performs object recognition on the group of objects; and
determining, based on the entity allocation information, an entity corresponding to a group identifier of the at least one group of objects as the target entity.

16. The device according to claim 9, wherein the acts further comprise:
updating entity allocation information based on the target entity and the at least one group of objects, the entity allocation information indicating at least a correspondence between a group of objects and an entity that performs object recognition on the group of objects.

17. A non-transitory computer-readable storage medium storing a computer program that, when executed by a processor, implements acts including:
obtaining an aggregation result of a plurality of objects, the aggregation result comprising at least one group of objects aggregated based on a similarity;
determining a target entity that matches the at least one group of objects for performing object recognition; and
providing the at least one group of objects to the target entity.

18. The non-transitory computer-readable storage medium according to claim 17, wherein obtaining the aggregation result of the plurality of objects comprises:
obtaining the aggregation result by classifying the plurality of objects based on the similarity.

19. The non-transitory computer-readable storage medium according to claim 17, wherein obtaining the aggregation result of the plurality of objects comprises:
determining a similarity between an object to be aggregated and a group of objects in the at least one group of objects comprised in the aggregation result; and
in response to determining that the similarity is greater than a predetermined threshold, adding the object to be aggregated to the group of objects.

20. The non-transitory computer-readable storage medium according to claim 17, wherein determining the target entity comprises:
determining at least one of text information or image information of the at least one group of objects;
obtaining entity information of a plurality of candidate entities, the entity information indicating at least one of a recognition duration or a recognition accuracy of each of the plurality of candidate entities; and
determining the target entity from the plurality of candidate entities based on the at least one of the text information or the image information and the entity information.
